(19) United States
(12) Patent Application Publication
(10) Pub. No.: US 2007/0277800 A1
(43) Pub. Date: Dec. 6, 2007

(54) Barbecue

(76) Inventor: Chih-Ming Chiang, Taichung (TW)

Correspondence Address: Thomas E. Sisson;Jackson Walker, LLP, Suite 2100, 112 E. Pecan, San Antonio, TX, 78205, US

(21) Appl. No.: 11/434,366

(22) Filed: May 15, 2006

(51) Int. Cl. F24B 3/00; A47J 37/00

(52) U.S. Cl. 126/25 R; 126/50

(57) ABSTRACT

A barbecue has a body, a charcoal bracket and at least one food drawer. The body has a front wall with a mouth and multiple vents defined in the front wall, a central cavity and at least one side cavity. The charcoal bracket is received inside the central cavity in the body. The charcoal bracket has a barbecue grill mounted on the charcoal bracket. The at least one food holder is received in the at least one side cavity. When the barbecue is in use, the heat conducting from the charcoal bracket may bake foods inside the food holders.

### BACKGROUND OF THE INVENTION

1. Field of the Invention

The present invention relates to a barbecue, and more particularly to a barbecue that is convenient in use.

2. Description of Related Art

Barbecues which use charcoal in briquette or similar form as a heating source for cooking are well known and widely used. When a conventional barbecue is used, the heat generated by charcoal only is applied for cooking food but not for another usage.

To overcome the shortcomings, the present invention tends to provide a barbecue to mitigate the aforementioned problems.

### SUMMARY OF THE INVENTION

The primary objective of the present invention is to provide a barbecue that is convenient for use.

A barbecue has a body, a charcoal bracket and at least one food drawer. The body has a front wall with a mouth and multiple vents defined in the front wall, a central cavity and at least one side cavity. The charcoal bracket is received inside the central cavity in the body. The charcoal bracket has a barbecue grill mounted on the charcoal bracket. The at least one food holder is received in the at least one side cavity.

When the barbecue is in use, the heat conducting from the charcoal bracket may bake foods inside the food holders.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a barbecue in accordance with the present invention;

FIG. 2 is a perspective view of the barbecue in FIG. 1 with a lid being opened;

FIG. 3 is an exploded perspective view of the barbecue in FIG. 1;

FIG. 4 is a perspective view of a second embodiment of a barbecue in accordance with the present invention;

FIG. 5 is a perspective view of the barbecue in FIG. 4 with a lid being opened; and

FIG. 6 is an exploded perspective view of the barbecue in FIG. 4.

### DETAILED DESCRIPTION OF THE PREFERRED EMBODIMENT

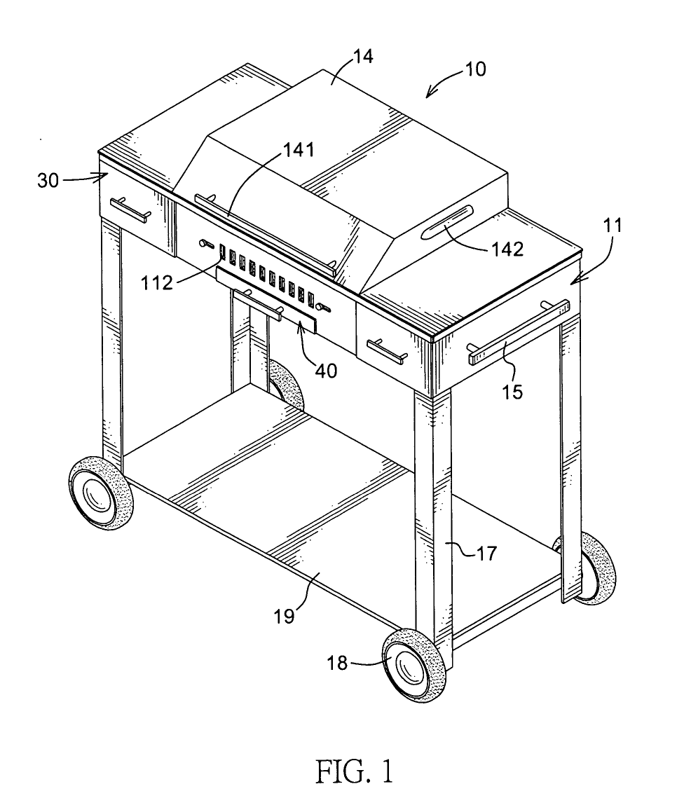

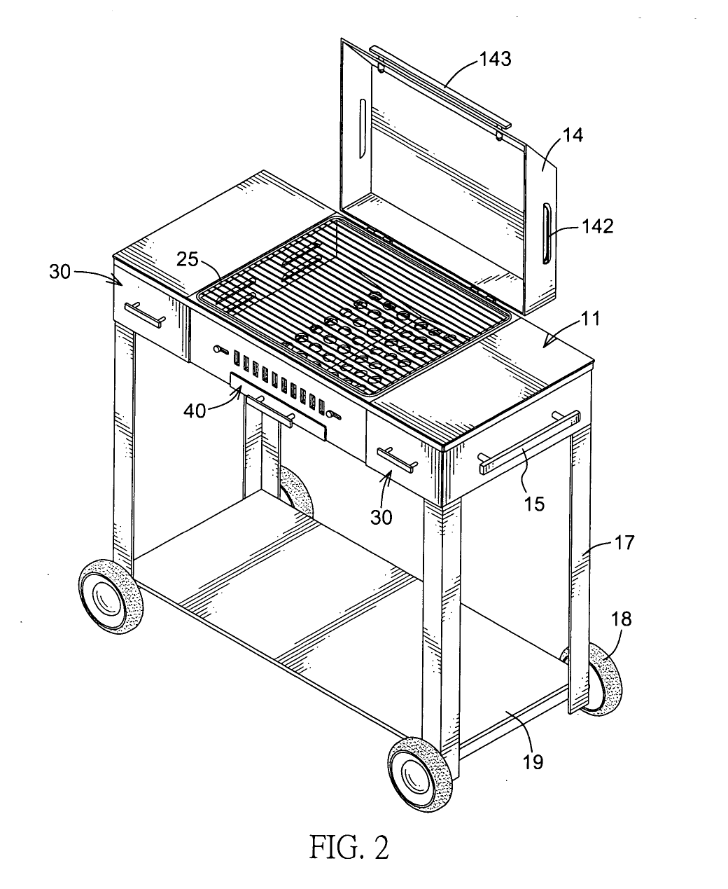

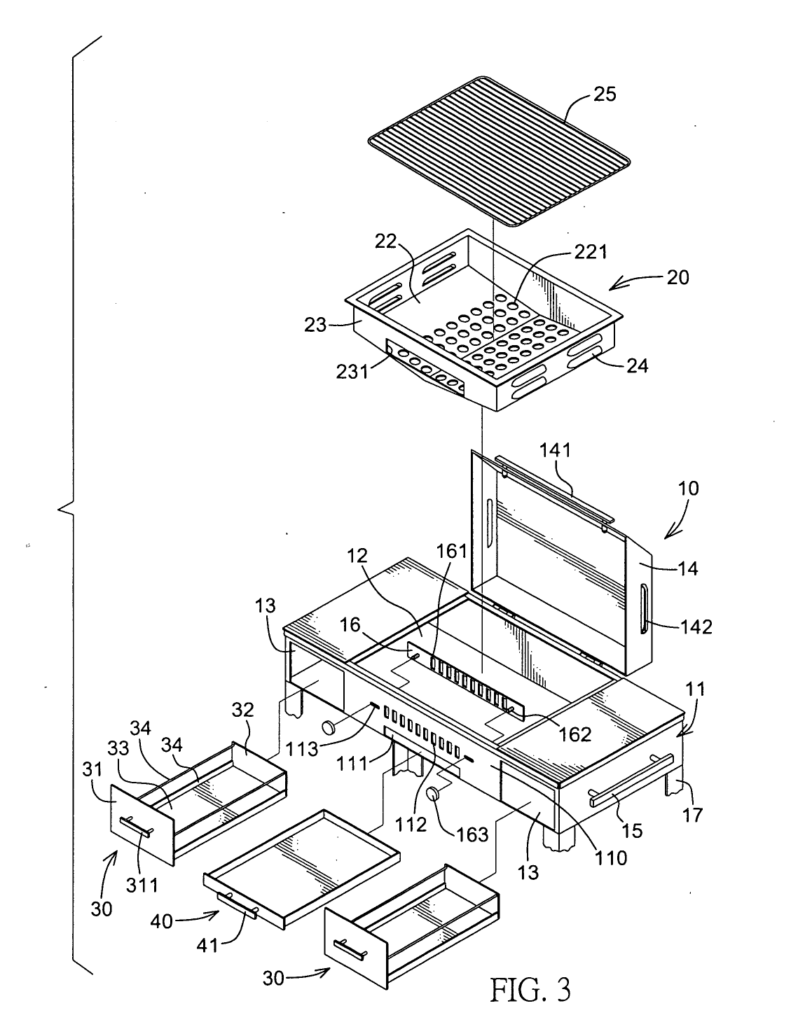

With reference to FIGS. 1 to 3, a first embodiment of a barbecue (10) in accordance with the present invention comprises a body (11), a charcoal bracket (20), at least one food holder (30) and a dust drawer (40).

The body ( 11) has a height, a top, a bottom, a front wall (110), two sidewalls, a central cavity (12), at least one side cavity (13), a lid (14), two handles (15), a controlling piece (16), four legs (17), four wheels (18) and a holding plate (19). The top has a center. The front wall (110) has an inner surface, a center, a mouth (111), multiple vents (112) and two mounting slots (113). The mouth (111) is defined in the front wall (110) near the bottom of the body (11). The multiple vents (112) are separately defined in the front sidewall (110) above the mouth (111) in the front wall (110). The mounting slots (113) are defined in the front wall (110) respectively at two sides of the multiple vents (112). The central cavity (12) is defined in the body (11) at the center of the top and communicates with the multiple vents (112) in the front wall (110). The central cavity (12) forms a top opening in the top. The at least one side cavity (13) is defined in body (11) at the front wall (110) besides the central cavity (12) and communicates with the central cavity (12). In a preferred embodiment, two side cavities (13) are respectively defined besides the central cavity (12) and the two side cavities (13) form two front openings in the front sidewall (110). The lid (14) is pivotally mounted on the top of the body (11) to seal the top opening in the top. The lid (14) has a front surface, two side surfaces, a handle (141) and two vents (142). The handle (141) is mounted on the front surface of the lid (14). The two vents (142) are formed in the side surfaces of the lid (14).

The two handles (15) are mounted on the two sidewalls of the body (11). The controlling piece (16) is mounted on the inner surface of the front sidewall (110) and has multiple vents (161), two threaded posts (162) and two nuts (163). The vents (161) are separately defined in the controlling piece (16) and correspond respectively to the vents (112) in the front sidewall (110). The threaded posts (162) are mounted on the controlling piece (16) and extend out from the mounting slots (113) in the front wall (110). The nuts (163) are respectively screwed onto the threaded posts (162) extending out the mounting slots (113). Therefore, the controlling piece (16) will move along the mounting slots (113) in the front sidewall (110) of the body (11). The four legs (17) are mounted on the bottom of the body (11) and each leg (17) has a free end. The four wheels (18) are respectively mounted on the free ends of the corresponding legs (17). The holding plate (19) is mounted between the four legs (17) near the free ends.

The charcoal bracket (20) is received inside the central cavity (12) in the body (11) and is mounted onto the top opening in the top. The charcoal bracket (20) has a height, a length, a top opening, a top edge, a top lip (21), a bottom (22), two sidewalls, a front wall (23), multiple vents (24) and a barbecue grill (25). The height of the charcoal bracket (20) is less than the height of the body (11). The top lip (21) is formed around the top edge of the charcoal bracket (20) for mounting onto the top opening in the top. The bottom (22) of the charcoal bracket (20) is a V-shaped bottom and has multiple holes (221) defined through the bottom (22). The front wall (23) corresponds to the front sidewall (110) of the body (11) and has a mouth (231). The mouth (231) is defined in the front wall (23) of the charcoal bracket (20) and corresponds to the multiple vents (112, 161) in the front wall (110) and the controlling piece (16) of the body (11). The multiple vents (24) are formed through the two sidewalls. In a preferred embodiment, four vents are formed in the each sidewall of the charcoal bracket (20). The barbecue grill (25) is mounted on the top lip (21) for supporting foods on the barbecue grill (25).

The at least one food holder (30) is received mounted the at least one side cavity (13) in the body (11). In the first embodiment of the present invention, two food holders (30) are respectively received inside the side cavities (13) in the body (11) and each the food holder (30) is like as a drawer. The food holder (30) has a front wall (31), a rear wall (32), a bottom (33) and four steel strings (34). The front wall (31) has a handle (311) mounted on the front wall (31) for conveniently sliding the food holder (30) out from the corresponding side cavity (13). The the steel strings (34) are mounted respectively on the sidewalls between the front wall (31) and the rear wall (32).

The dust drawer (40) is mounted inside the mouth (111) in the front wall (110) of the body (11) and has a length and a handle (41). The length of the dust drawer (40) is almost equal to that of the charcoal bracket (20). The handle (41) is mounted on the dust drawer (40).

When the barbecue in accordance with the present invention is in use, charcoal is supported on the charcoal bracket (20) for providing heat for cooking food. Foods are set on the barbecue grill (25) and store inside the food holders (30). The foods set on the barbecue grill (25) may be meats, fishes and so on. Because the central cavity (12) communicates with the side cavities (13), the foods store inside the food holders (30) may be vegetables which are cooked by the heat conducting from the vents (24) in the charcoal bracket (20). Therefore, the foods stored inside the food holders (30) are baked by the heat conduct from the charcoal bracket (20) and will not be scorched easily. Furthermore, because the controlling piece (16) can move along the mounting slots (113) in the front wall (110) of the body (11), ventilation will be changed by moving the controlling piece (16).

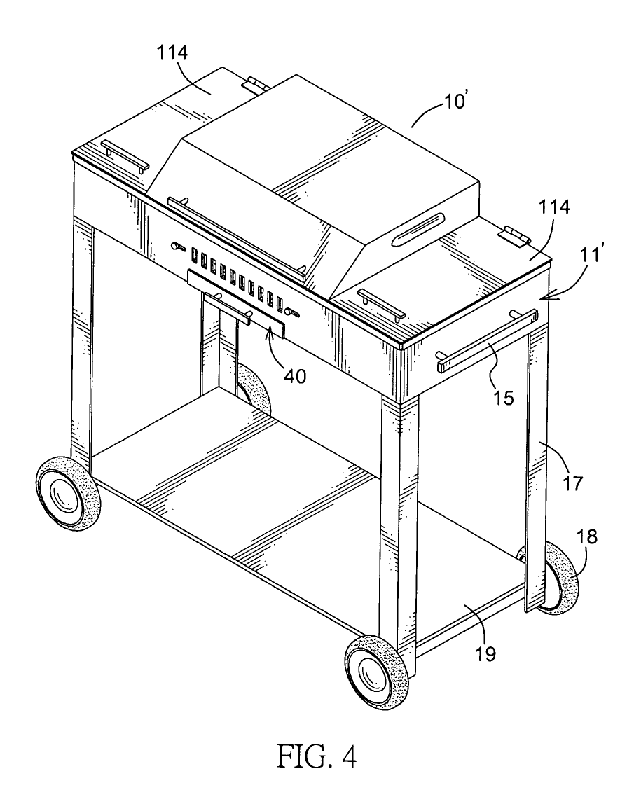

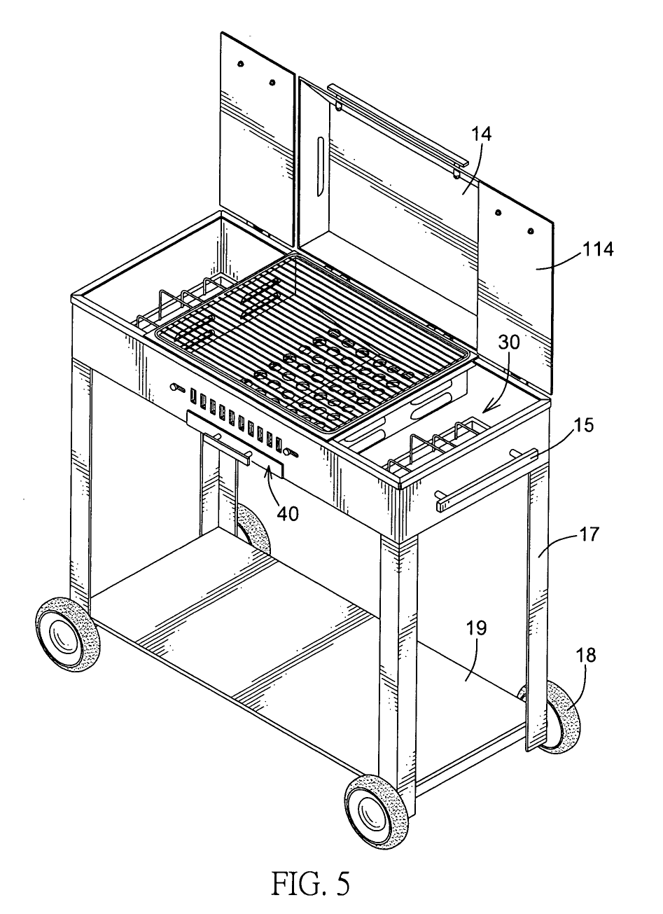

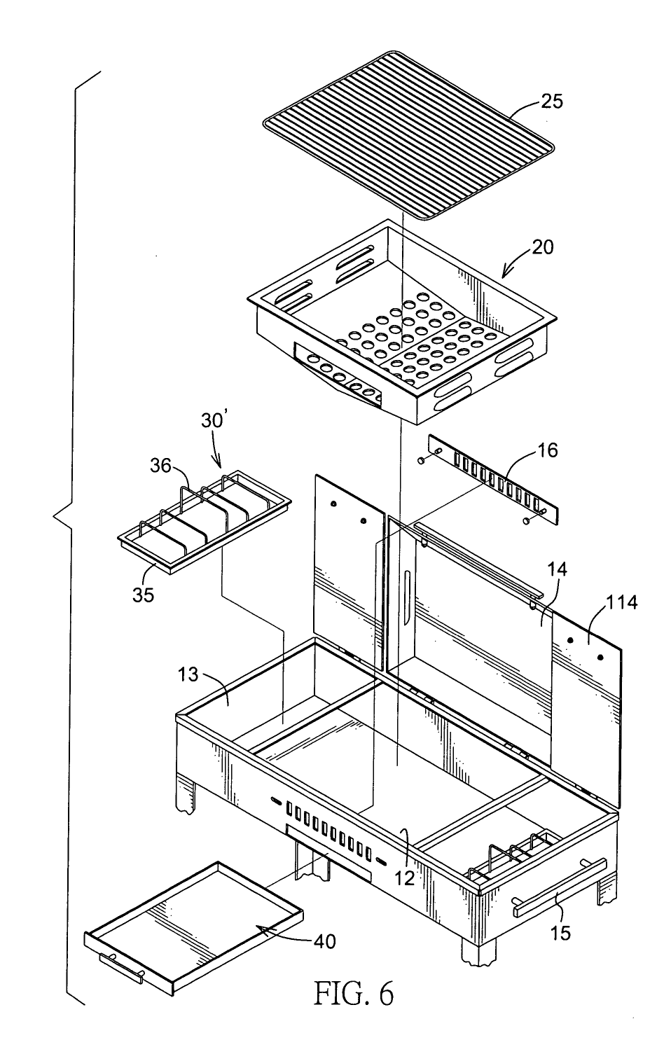

With reference to FIGS. 4 to 6, a second embodiment of a barbecue in accordance with the present invention is almost the same as the first embodiment, excepts the type of the food holders (30′) and the side cavities (13) in the body (11).

The body (11 ′) has a height, a top, a bottom, a front wall (110), a rear wall, two sidewalls, a central cavity (12), at least one side cavity (13), a lid (14), two optional handles (15), a controlling piece (16), four optional legs (17), four optional wheels (18) and an optional holding plate (19). The elements and the method for assembling the elements are almost the same as the first embodiment and not further describe, but the differences are described as follow.

The body (11) further comprises two top side lids (114). Two top side openings are defined in the top of the body (11 ′) and respectively correspond to and communicate with the side cavities (13) in body (11). The two top side lids (114) are pivotally mounted on and close the top side openings in the top of the body (11′).

The food holders (30′) are respectively received inside the side cavities (13) and each food holder (30) is a bracket. Each food holder (30′) has a base plate (35) and multiple crutches (36) mounted on the base plate (35).

The advantages of the barbecue in accordance with the present invention describe as follows.

1. Dust generated by the used charcoal may be collected in the dust drawer (40), therefore, to clean the dust drawer (40) is convenient for a user.

2. The food holders can hold foods that easily become scorched inside to bake the foods by the heat conducting from the charcoal bracket (20), such that the foods will not be scorched easily and healthy for eating.

3. Ventilation of the charcoal bracket (20) can be adjusted by moving the controlling piece (16) mounted on the body (11), so the barbecue provides an easy way of use.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A barbecue comprising:
a body having
a height,
a top having a center,
a bottom,
a front wall having
an inner surface,
a center,
a mouth defined in the front wall near the bottom of the body, and
multiple vents separately defined in the front wall above the mouth in the front sidewall,
two sidewalls,
a central cavity defined in the body at the center of the top, communicating with the multiple vents in the front wall and forming a top opening in the top, and
at least one side cavity defined in body and communicating with the central cavity,
a charcoal bracket received inside the central cavity in the body and mounted on the top opening in the top, having
a height being less than the height of the body,
a length,
a top opening,
a top edge,
a top lip formed on the top edge of the charcoal bracket for mounting the charcoal bracket on the top opening in the top of the body,
a bottom having multiple holes defined through the bottom,
two sidewalls,
a front wall corresponding to the front wall of the body and having
a mouth defined in the front wall of the charcoal bracket and corresponding to the multiple vents in the front wall of the body,
multiple vents formed on the two sidewalls of the charcoal bracket, and
a barbecue grill mounted on the top lip for supporting foods on the barbecue grill, and
at least one food holder respectively mounted in the at least one side cavity.

2. The barbecue as claimed in claim 1, wherein the front wall of the body further comprises two mounting slots respectively defined in front wall and respectively at two sides of the multiple vents, and
the body further comprises
a lid pivotally mounted on the top of the body and corresponding to the top opening in the top, and
a controlling piece mounted on the inner surface of the front wall of the body and having
multiple vents separately defined in the controlling piece and corresponding to the vents in the front wall of the body,
two threaded posts mounted on the controlling piece and extending out from the mounting slots in the front wall of the body, and
two nuts mounted respectively on the threaded posts on the controlling piece and extending out from the mounting slots in the front wall of the body.

3. The barbecue as claimed in claim 2, wherein the body further comprises
four legs mounted on the bottom of the body and each leg having a free end,
four wheels respectively mounted on the free ends of the corresponding legs, and
a holding plate mounted between the four legs near the free ends.

4. The barbecue as claimed in claim 3, wherein the body comprises two side cavities forming two front openings in the front wall of the body, and
two food holder respectively received inside the side cavities and each having
a front wall having a handle mounted on the front wall,
a rear wall,
a bottom, and
four steel strings mounted respectively on the sidewalls between the front wall and the rear wall.

5. The barbecue as claimed in claim 3, wherein the body comprises two side cavities forming two top side openings in the front wall of the body, and
two food holder respectively received inside the side cavities and each having
a base plate, and
multiple crutches mounted on the base plate.

6. The barbecue as claimed in claim 4, wherein the bottom of the charcoal bracket is a V-shaped bottom.

7. The barbecue as claimed in claim 5, wherein the bottom of the charcoal bracket is a V-shaped bottom.

8. The barbecue as claimed in claim 1, wherein the body further comprises
four legs mounted on the bottom of the body and each leg having a free end,
four wheels respectively mounted on the free ends of the corresponding legs, and
a holding plate mounted between the four legs near the free ends.

9. The barbecue as claimed in claim 1, wherein the body comprises two side cavities forming two front openings in the front wall of the body, and
two food holder respectively received inside the side cavities and each having
a front wall having a handle mounted on the front wall,
a rear wall,
a bottom, and
four steel strings respectively mounted on the sidewalls between the front wall and the rear wall.

10. The barbecue as claimed in claim 1, wherein the body comprises two side cavities forming two top side openings in the front wall of the body, and
two food holder respectively received inside the side cavities and each having
a base plate, and
multiple crutches mounted on the base plate.

11. The barbecue as claimed in claim 1 further comprising a dust drawer received inside the mouth in the front wall of he body and having a handle mounted on the dust drawer.
